(19) United States
(12) Patent Application Publication
(10) Pub. No.: US 2012/0097827 A1
(43) Pub. Date: Apr. 26, 2012

(54) HOLDING DEVICE FOR A BEARING OF AN AXLE STABILIZER

(75) Inventors: Holger Klink, Muehltal (DE); Reinhold G. Platz, Seeheim-Jugenheim (DE); Bernhard Aumer, Fischbach (DE); Dieter Schneegans, Emmerich (DE); Rudolf Gattringer, Tragwein (AT)

(73) Assignees: Schneegans GmbH, Emmerich am Rhein (DE); BASF SE, Ludwigshafen (DE)

(21) Appl. No.: 13/380,070

(22) PCT Filed: Jun. 24, 2010
(86) PCT No.: PCT/EP10/59030

§ 371 Date: Dec. 22, 2011

(30) Foreign Application Priority Data
Jun. 25, 2009 (EP) 09163810.6

(51) Int. Cl. F16M 13/02; G06F 17/50

(52) U.S. Cl. 248/635; 248/634; 703/1

(57) ABSTRACT

The invention relates to a holding device for a bearing of an axle stabilizer in a motor vehicle, comprising a mount of an elastic material for the axle stabilizer and a holding bracket (1), which at least partially encloses the mount of the elastic material. The holding bracket (1) is produced from a polymer material and has a geometry which corresponds to a geometry determined by the following steps:
(a) calculating a degree of utilization of the strength of the holding bracket (1) by a simulation calculation,
(b) adapting the geometry of the holding bracket (1) and/or the position of the at least one gating point of the holding bracket (1) to the result of the simulation calculation, a lessening of the wall thickness, a reduction in the number of stiffening elements (7) or a decrease in size of the stiffening elements (7) taking place when the degree of utilization exceeds a prescribed upper limit value and an increase in the wall thickness, an increase in the number of stiffening elements (7) or a strengthening of the stiffening elements (7) taking place when the degree of utilization falls below a prescribed lower limit value,
(c) repeating steps (a) and (b) when a change in the geometry of the holding bracket (1) and/or of the position of the at least one gating point has taken place in step (b).

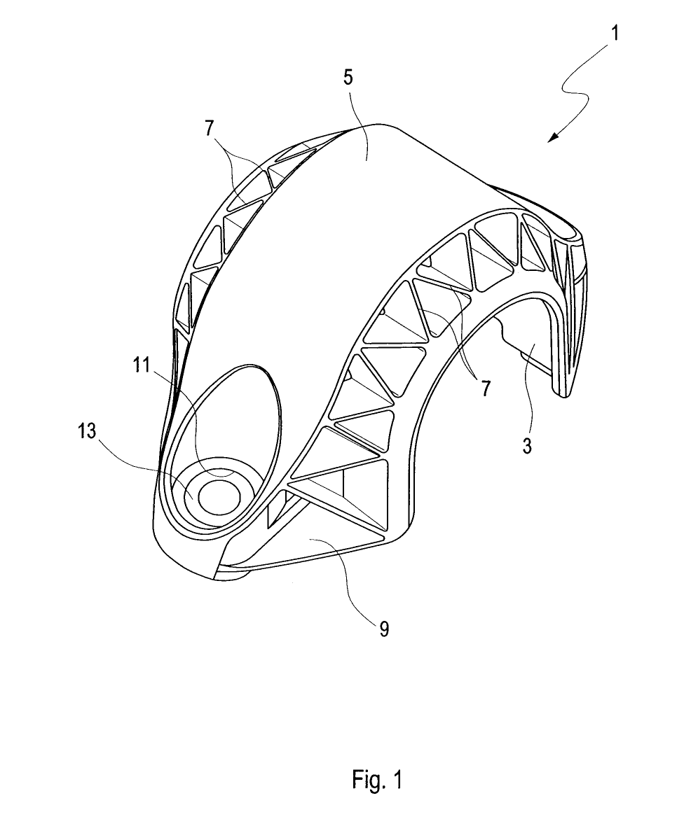

The invention relates to a holding device for a bearing of an axle stabilizer in a motor vehicle, comprising a mount of an elastic material for the axle stabilizer and a holding bracket, which at least partially encloses the mount of the elastic material.

Axle stabilizers are used in motor vehicles in order for example to transfer forces from one wheel of the vehicle to the other wheel also, in order for example to reduce uneven loads in this way. An axle stabilizer is usually formed in the form of a rod. This is fixed in the vicinity of the wheels to the spring struts or to the vehicle body. Suitable holding devices are used for the fixing of the axle stabilizer. Holding devices usually have a holding bracket and a mount of an elastomer material. The axle stabilizer is enclosed by the mount of elastomer material and the latter is fastened with the aid of the holding bracket.

At present, holding brackets are usually produced from metal, in order to be able to absorb the loads acting on them. Such a holding bracket is disclosed for example in DE 10 2005 002 889 A1.

The mount of the elastomer material serves the purpose of damping relative movements of the axle stabilizer in relation to the holding bracket. Since the elastic material of the mount is usually not solidly connected to the holding bracket but is loosely enclosed by it, the relative movements of the axle stabilizer can have the effect that the mount of the elastic material moves in the holding bracket. This may on the one hand lead to a development of noise due to alternating sticking and slipping in the holding bracket; on the other hand the elastic material also undergoes strong mechanical loading which may lead to wearing of the mount of elastic material.

A further disadvantage of the metallic holding bracket is its comparatively high weight. The high weight of components has the overall effect, however, of increased fuel consumption.

It is an object of the present invention to provide a holding device for a bearing of an axle stabilizer which has a lower weight than a holding device with a holding bracket of metal.

The object is achieved by a holding device for a bearing of an axle stabilizer in a motor vehicle, comprising a mount of an elastic material for the axle stabilizer and a holding bracket, which at least partially encloses the mount of the elastic material, the holding bracket being produced from a polymer material and having a geometry which corresponds to a geometry determined by the following steps:
(a) calculating a degree of utilization of the strength of the holding bracket by a simulation calculation,
(b) adapting the geometry of the holding bracket and/or the position of the at least one gating point of the holding bracket to the result of the simulation calculation, a lessening of the wall thickness, a reduction in the number of stiffening elements or a decrease in size of the stiffening elements taking place when the degree of utilization exceeds a prescribed upper limit value and an increase in the wall thickness, an increase in the number of stiffening elements or a strengthening of the stiffening elements taking place when the degree of utilization falls below a prescribed lower limit value,
(c) repeating steps (a) and (b) when a change in the geometry of the holding bracket and/or of the position of the at least one gating point has taken place in step (b).

It is possible by the geometry determined in accordance with steps (a) to (b) to form the holding bracket in such a way that the smallest possible amount of polymer material can be used for the holding bracket by optimizing the wall thicknesses and the arrangement and number of strengthening elements, so that it is possible to save weight. On account of the loading which acts on the holding bracket and the lower strength of polymer material in comparison with steel, it is necessary to make the holding bracket very much more complex when it is produced from a polymer material in order for it to be able to absorb the forces acting on it without failing. Failure may take place for example by deforming or by rupturing. With a geometry which does not follow a geometry determined by steps (a) to (c), a form of the holding bracket strengthened because of the lower strength of the polymer material would require such a large amount of polymer material that there is no weight saving in comparison with a holding bracket of steel, or at least only such a small weight saving that use of the polymer material is not worthwhile.

In a preferred embodiment, the holding bracket has two peripheral supporting walls, which are connected to one another by a ribbed structure. The ribbed structure allows forces to be transferred from the inner wall to the outer wall. As a difference from a holding bracket of solid material, the ribbed structure allows material to be saved and therefore the weight to be reduced. The geometry determined by steps (a) to (c) allows the number and thickness of the ribs to be optimized, so that a best possible force transfer can take place from the inner wall to the outer wall with least possible use of material. In particular, it is therefore possible for example to provide more ribs or ribs with a greater wall thickness at positions at which a great force occurs, whereas the number of ribs or their wall thickness can be reduced at places at which only a small loading occurs. The thickness of the walls, and perhaps the form of the outer wall, may also be adapted to the loads occurring.

The polymer material from which the holding bracket is produced is preferably a fiber reinforced plastic. The use of a fiber reinforced plastic allows the mechanical properties of the polymer material, in particular its tensile strength, to be improved. An improvement in the tensile strength is in this case generally obtained in the direction of orientation of the fibers.

The holding bracket of polymer material is generally produced by an injection molding process. If a fiber reinforced plastic is used as the polymer material, the fiber orientation is also dependent on the injection parameters and the gating point. In order to be able to determine the degree of utilization of the strength, when using a fiber reinforced plastic it is therefore necessary for determining the suitable geometry of the holding bracket to carry out prior to the calculation of the degree of utilization of the strength of the holding bracket in step (a) a simulation calculation to determine the orientation of the fibers in the fiber reinforced plastic and the weld lines in the component. This is necessary since both the orientation of the fibers and the weld lines in the component have an influence on the strength, in particular when a fiber reinforced plastic is used, on account of the change in the fiber orientation in the region of the weld lines.

Suitable polymer materials which can be used for producing the holding bracket are, in particular, thermoplastic polymers. Preferred plastics are polyamides, polyesters, polyacetals, polysulfone, polyethersulfone, polyphenylene sulfone, polybutylene terephthalate and polyolefins, for example polypropylene or polyethylene, or mixtures thereof. Most particularly suitable are polyamides, for example polyamide 6 or polyamide 6.6.

Fibers which can be used for the reinforcement are, in particular, glass fibers, carbon fibers or aramid fibers. Short fibers are generally used, that is to say fibers with a fiber length of less than 0.5 mm, with preference less than 0.4 mm. However, so-called long fibers, that is to say fibers up to a length of several millimeters, with preference with a length of up to 20 mm, may also be used. However, short fibers are preferred. Short glass fibers are most particularly preferred.

The determination of the geometry for the holding bracket by steps (a) to (c) and, if a fiber reinforced plastic is used, additionally the determination of the orientation of the fibers in the fiber reinforced plastic and the weld lines in the holding bracket are necessary since polymers exhibit a pronounced nonlinear stress and strain behavior under high loads. This behavior is generally also strongly dependent on the rate of straining.

In the case of great rates of straining, generally very much higher yield stresses are achieved than in the case of slow loading. Moreover, in the case of many polymers, the yield stress is much higher in the compressive range than in the tensile range. In addition, under great strains, inelastic components remain, components which no longer relax completely when the load is removed. Plastics consequently exhibit very complex, nonlinear-viscoplastic behavior.

Since fiber reinforced thermoplastic materials exhibit better mechanical properties than unreinforced thermoplastics, the fiber reinforced thermoplastic materials are of particular interest for the holding bracket. On account of the orientation of the fibers brought about by the processing process, in particular during the injection molding of the component, the mechanical properties of the fiber reinforced thermoplastic materials are no longer isotropic. This leads to an anisotropic, that is to say direction-dependent, mechanical behavior of the stiffness, yield stress and elongation at break of the material.

On account of the driving motion and the vibrations of the wheels occurring during driving, which may be uneven, for example due to unevennesses in the surfacing of the roadway, uneven dynamic loading of the holding bracket occurs. This uneven loading of the component leads to loading that is different from constant loading. On account of the continual changing of the load on the component, even a small load may lead to failure of the component. This behavior is taken into account by the determination of the geometry by steps (a) to (c) and the determination of the orientation of the fibers and the weld lines in the component.

The determination of the geometry by steps (a) to (c) and the additional simulation calculation for determining the orientation of the fibers in the fiber reinforced plastic and the weld lines in the holding bracket make it possible to adapt the geometry of the holding bracket to the locally occurring loading. The geometry of the holding bracket is understood for the purposes of the present invention as meaning for example the wall thickness, thickness and height of strengthening elements and the form of the holding bracket. Strengthening elements are, for example, ribs on the holding bracket. So, for example, regions of the holding bracket in which low loading occurs may be made with a smaller wall thickness and regions of the holding bracket which undergo higher loading may be made with a greater wall thickness. This design allows material to be saved, and consequently weight to be saved. Moreover, it is possible to adapt the wall thickness of the component to the corresponding local loading, whereby a reduction in the required installation space is possible.

If a fiber reinforced plastic is used, the determination of the orientation of the fibers and the weld lines preferably takes place by simulation of the production process of the holding bracket. Apart from the orientation of the fibers and the weld lines, variables that are likewise involved in the process, for example pressure distribution and temperature, are determined by the simulation of the production process.

The orientation distribution density of the fibers in the holding bracket is generally in-homogeneous and depends on the production process. For an injection molding process, as preferably used for the production of the holding bracket, the orientation distribution density of the fibers is calculated from the data of the simulation of the injection molding process by means of numerical integration from the extended Jeffery equation, as described for example in G. B. Jeffery, “The motion of ellipsoidal particles immersed in a viscous fluid”, Proc. of the Royal Society of London, Series A, 1922, pages 161-179. This gives a fiber orientation tensor for every location in the component, from which there follows an approximation for the orientation distribution density.

To calculate the degree of utilization of the strength of the holding bracket by the simulation calculation in step (a) it is necessary for the fiber reinforced polymer material to be numerically described. The numerical description takes place here by a material law which is based on a viscoplastic theorem for the polymer material and on an elastic model for the fibers, which is combined with a micromechanical model for the description of the material composite, that is to say the fiber reinforced polymer material. The polymer material is described with an elastic-plastic material model. The plastic potential comprises not only the generally customary first invariant of the deviator of the stress tensor but also a polynomial theorem in the second and third invariants. The flow rule has a nonassociative formulation. The potential likewise comprises not only the first invariant of the deviator but also terms of the second and third invariants. The viscosity is formulated by allowing the flow condition to be temporarily violated. The projection back onto the yield surface is time-dependent through a viscous term. For permanent loading, the solution is achieved numerically by iteration over correspondingly long times. The strength hypothesis for the polymer is based on failure surfaces that likewise comprise not only the first invariant but also the second and third invariants of the stress tensor. The strain rate dependence is incorporated in the failure description by way of weighting. The calibration of the parameters of the model is based on tension, shear and compression tests.

If a fiber reinforced plastic is used for the fiber material, elastically brittle behavior is assumed. Parameters here are the rigidity and the breaking stress of the fiber material.

The micromechanical model of the material composite is based on a homogenization process according to Mori-Tanaka, described in T. Mod and K. Tanaka, “Average stress in matrix and average elastic energy of materials with misfitting inclusions”, Acta Metallurgica, Vol. 21, May 1973, pages 571-574 and J. D. Shelby, “The determination of the elastic field of an ellipsoidal inclusion, and related problems”, Proc. of the Royal Society of London, Series A, 1957, pages 376-396. Here, the contributions to the material behavior of the two phases, that is to say polymer and fibers, are numerically weighted with respect to one another. Considered here as parameters are the fiber content, the geometry and the orientation distribution density of the fibers.

The material law allows determination of the anisotropy through the fibers in the polymer, the nonlinearity and the strain rate dependence resulting from the polymer material, which leads to the known tension/compression asymmetry, and also the failure behavior. Failure occurs if the polymer matrix fails, the fibers break or the matrix becomes detached from the fibers. Moreover, the material law can be coupled in a simple way with a simulation for the process.

The calculation of the degree of utilization of the strength in step (a) takes place by a customary numerical method. Such numerical methods are generally finite difference methods, finite element methods and finite volume methods. A finite element method is preferably used for the calculation of the degree of utilization of the strength. To be able to carry out the numerical calculation, it is necessary to describe the holding bracket by a grid network. For this purpose, the contour of the holding bracket is depicted in the form of a grid network. Customary grid networks that are used in finite element methods are triangular grids and rectangular grids. The mesh width of the grid, i.e. the spacing between two respectively joined points, is chosen such that a sufficiently accurate depiction of the holding bracket is possible by the grid network. Complex regions consequently require a smaller mesh width, while a greater mesh width is adequate in less complex regions. Since, for the strength calculation, it is not adequate just to model the surface of the holding bracket, but it is also necessary to model the internal regions, the entire holding bracket is depicted in the form of a spatial grid network.

If a fiber reinforced plastic is used, to calculate the degree of utilization of the strength the orientation of the fibers in the fiber reinforced plastic and the weld lines determined in the simulation calculation for determining the orientation of the fibers in the fiber reinforced plastic and the weld lines are transferred to the grid network. Further variables that are required for the calculation of the degree of utilization of the strength are material variables of the plastic and of the fibers. In particular, relevant material variables are, for example, the modulus of elasticity, Poisson's ratio, parameters for the plastic potential, viscosity parameters and rupture strengths of the polymer, fiber geometry and delamination resistance as well as the modulus of elasticity, Poisson's ratio and tensile strength of the fibers. The pressure dependence and temperature dependence of the individual material data must also be respectively taken into account here. From these variables, the strength-relevant characteristic values for the fiber reinforced polymer material are calculated by means of the micromechanical model for the description of the material composite.

If an injection molding process is used for producing the holding bracket, the simulation calculation for determining the orientation of the fibers in the fiber reinforced plastic and the weld lines in the holding bracket is a modeling of the injection molding process. For this purpose, generally the injection nozzle and the injection mold are depicted by a grid network. The injection operation of the polymer mass comprising fibers is described by the modeling. For this purpose, it is necessary to describe the entire injection operation during which polymer mass is injected into the mold. Apart from the three-dimensional local description of the mold, a time profile of the injection operation must also be described. The time profile of the injection process gives the orientation of the fibers over time in the polymer mass. At the same time, the position of the weld lines in the component is also described by this.

Further variables that are described by the modeling of the production process are, in particular, the pressure variation and the temperature variation. The pressure variation and the temperature variation are in this case represented both temporally and locationally. Once the strength-relevant characteristic values for the fiber reinforced polymer material in the holding bracket have been determined from the material data, the orientation distribution density of the fibers and the position of the weld lines, it is possible to assess the degree of utilization of the strength. For this purpose, a strength simulation is carried out on the holding bracket.

The local loading on the holding bracket is used as a boundary condition for the strength simulation. To be able to determine the necessary strength that the holding bracket must have, here too it is necessary again to determine the time profile over a great period of time. In particular, dynamic loading must be taken into account here. The weak points of the holding bracket are determined by the strength simulation. For example, it shows at which points of the holding bracket bending or shearing occurs for example under given loading. If the damage to the holding bracket occurs under loading that is lower than the loading to which the holding bracket is exposed, it is necessary to increase the wall thickness at these points. At the same time, it is possible to choose a lower wall thickness at those points at which no failure of the holding bracket occurs. In this way, the wall thickness of the component can be adapted locally to the respective loading that occurs. This has the effect that material can be saved in the later production of the component by optimum design of the wall thickness, since it is not necessary for the entire component to be made with the maximum wall thickness. This leads to a weight saving, by which a lower fuel consumption of the vehicle is made possible. Moreover, in this way the installation space for the holding bracket can optionally also be optimized.

In order to dampen loads on the holding bracket and in particular also avoid every movement of the axle stabilizer being transferred to the body, the axle stabilizer is mounted in a mount of an elastic material. The mount of the elastic material is fitted with the aid of the holding bracket on the body of the motor vehicle or else on a spring strut or a spring strut fork of the wheel suspension.

The mount of the elastic material may be made for example in the form of two half-shells or as a one-part mount that is laterally slit. However, any other desired suitable form that is known to a person skilled in the art is also possible.

Suitable for example as the elastomer material for the mount for the axle stabilizer is natural rubber (NR), ethylene-propylene-diene terpolymer (EPDM), nitrile butadiene rubber (NBR), styrene-butadiene rubber (SBR), thermoplastic polyurethanes (TPU) and silicones. Of these, natural rubber and ethylene-propylene-diene terpolymer are particularly preferred.

In order that the mount of the elastic material cannot be displaced in relation to the holding bracket, in the case of holding brackets of steel, as are known from the prior art, flanged edges are formed, acting as a stop for the mount of the elastic material. The mount of the elastic material is merely enclosed by the holding bracket and held in its position in this way. This has the disadvantage that the elastic material of the mount can be pressed against the flanged edge by the movement of the axle stabilizer. Slipping and pressing together of the mount of the elastic material within the holding bracket is also possible, since there is no solid connection between the mount of elastic material and the holding bracket. This also has the effect that, when there is a displacement of the mount of elastic material, it is often retarded by the friction on the holding bracket and, if an adequately large force builds up, it slips a little more. This leads to development of considerable noise. As soon as the loading on the mount of elastic material is no longer applied, for example when the vehicle is at a standstill, the mount of the elastic material slips back again into the starting position, perhaps likewise with development of noise. As a result, loading is likewise applied to the mount of elastic material, which may lead to the mount of the elastic material becoming damaged.

If a polymer material is used for the holding bracket, the friction between the material of the holding bracket and the mount of the elastic material is reduced, so that the latter can slip within the holding bracket with little development of noise.

It is preferred, however, to encapsulate the mount of the elastic material with the polymer material for the holding bracket, whereby a stable connection is produced between the mount of the elastic material and the polymer material. The temperature of the polymer melt causes the polymer material to adhere to the elastic material of the mount.

An improvement in the adhesion of the elastic material of the mount and the polymer material of the holding bracket can be achieved if a primer is applied to the elastic material of the mount. The primer serves in this case as an adhesion promoter between the elastic material of the mount and the polymer material of the holding bracket. Suitable primers are known to a person skilled in the art and are commercially available.

The adhesion of the elastic material of the mount and the polymer material of the holding bracket has the advantage on the one hand that it is possible to dispense with the flanged edge for fixing the mount of elastic material and on the other hand that displacement of the mount of the elastic material in relation to the holding bracket is no longer possible. This leads to a further reduction in noise. It also has the effect of reducing the loading on the mount of the elastic material, since it is no longer compressed in the axial direction. The free cross section also becomes greater without the flanged edge on the outer surfaces of the mount of elastic material, so that there is a better distribution of the load here. Moreover, the mount of elastic material is no longer pressed against the flanged edge, which in the case of prior-art mounts leads to additional strong compressive loading.

In order to be able to fasten the holding bracket of polymer material to the motor vehicle, holding butt straps are preferably formed on the bracket. Bores through which the fastening means can be led in order to fasten the holding bracket are generally formed in the holding butt straps. Screws or rivets are used for example as fastening means.

If the holding bracket is fixed by screws, it is advantageous for bushes through which the screws are led for fastening to be mounted in the holding bracket. The use of bushes has the advantage that they cannot be pressed together by the holding force exerted on the screws and thereby damaged. There is also improved introduction of force into the holding bracket when loading is caused by relative movements of the stabilizer. The bushes are preferably produced from steel, aluminum, brass or magnesium. Alternatively, it is also possible to use bushes of a thermosetting material.

If the holding bracket is formed with butt straps for fastening, the bushes are arranged in the butt straps. The bushes may be introduced into the holding bracket for example during the production process. For this purpose, the bushes are placed in the mold and encapsulated by the polymer material for producing the holding bracket. Alternatively, it is also possible to form through-openings in the holding bracket and to introduce the bushes into these after the production of the holding bracket. It is also possible to connect the bushes for example to the screws and introduce them together with the screw into the holding bracket.

Use of the bushes avoids compressive forces being exerted on the holding bracket by the fastening means, forces which can lead to damage, for example cracking of the holding bracket.

Apart from the bushes, additional functional elements may be formed on the holding bracket. The additional functional elements may for example be molded directly onto the holding bracket during production. Such functional elements are, for example, additional guides, holding clips or fastening butt straps. These guides, holding clips or fastening butt straps may be used for example for fitting vibration dampers (absorbers), actuating lines, cables or other lines and covers, for example as underbody protection.

As an alternative to through-openings through which the holding bracket is screwed to the motor vehicle, it is also possible to clip the holding bracket in bores on the vehicle.

In one embodiment, the through-openings are provided with an elastomer material on their underside, that is to say on the side with which the holding bracket lies against the motor vehicle. This has the advantage that additional damping is realized. Alternatively or in addition, the elastomer material may also be provided on the inner wall of the holding bracket and extend over the butt straps for fastening the holding bracket.

Apart from the embodiment described above, in which the holding bracket is formed as one part, it is alternatively also possible to form the holding bracket as more than one part, for example as two parts. In this case, it is possible for example to form the holding bracket in two parts and to connect them to one another to form the holding bracket. The connection of the parts may take place for example by clipping.

The invention is described in more detail below on the basis of a drawing.

The single FIGURE shows a three-dimensional representation of a holding bracket according to the invention.

A holding bracket 1 according to the invention comprises an inner wall 3 and an outer wall 5. In the embodiment represented here, the inner wall 3 and the outer wall 5 are respectively formed in a substantially u-shaped manner and lie substantially parallel to one another. The width of the outer wall 5 is in this case less than the width of the inner wall 3. The inner wall 3 and the outer wall 5 are connected to one another by ribs 7. Forces which act on the inner wall 3 can be transferred via the ribs to the outer wall 5. This leads to an increase in the stability of the holding bracket 1.

For fastening the holding bracket 1, butt straps 9 are formed on the legs of the inner wall 3. The outer wall 5 widens steadily, so that the outer wall 5 and the butt straps 9 finish flush. A through-opening 11 is formed through the butt straps 9 and the outer wall 5. The through-opening 11 has a circular cross section and serves for fastening the holding bracket 1, for example to a body or to a spring strut. In order not to damage the holding bracket 1 by compressive stress of a screw head during the fastening of the holding bracket 1, bushes 13 are mounted in the through-openings 11. The bushes 13 absorb compressive forces from the screw head. This avoids a compressive force being exerted on the holding bracket 1 by fastening means.

The wall thicknesses of the inner wall 3 and of the outer wall 5 as well as the arrangement and wall thicknesses of the ribs 7 correspond to a geometry that has been determined according to steps (a) to (c) described above. The geometry determined in this way allows the smallest possible wall thickness and the minimum necessary number of ribs 7 to be determined, so that the weight of the holding bracket 1 can be minimized.

For the fastening of an axle stabilizer, a mount of an elastomer material is enclosed by the u-shaped inner wall 3. The axle stabilizer is enclosed by the mount of the elastic material, so that the mount of the elastic material acts as a damper. This means that part of the force acting on the axle stabilizer is absorbed by the mount of elastic material and, as a result, the force acting on the holding bracket 1 is reduced. In order to avoid displacement of the mount of elastic material in relation to the holding bracket 1 as a result of the forces acting on the mount of elastic material, it is advantageous to connect the mount of elastic material solidly to the holding bracket 1. For this purpose, the mount of elastic material can for example—as described above—be encapsulated directly by the material for the holding bracket 1, so that the holding bracket 1 adheres to the mount of elastic material. An improvement in the adhesion is produced for example by the use of a primer, which is applied to the mount of elastic material before the encapsulation.

Apart from the embodiment described above, according to which the mount of elastomer material is encapsulated with the material for the holding bracket, it is also possible first to produce the holding bracket from polymer material, preferably by an injection molding process, optionally to apply the primer to the holding bracket and subsequently to introduce the holding bracket with the primer into a vulcanizing mold. In the vulcanizing mold, the elastic material for the mount is then sprayed on and subsequently vulcanized.

1. A holding device comprising:
a mount comprising an elastic material; and
a holding bracket, which at least partially encloses the mount, comprising an inner support wall and an outer support wall, which are connected to one another by a ribbed structure comprising stiffening elements,
wherein the holding bracket is comprised of a polymer material and has a geometry obtained by a process comprising:
(a) calculating a degree of utilization of a strength of the holding bracket by a simulation calculation;
(b) adapting at least one selected from the group consisting of the geometry of the holding bracket and the position of at least one gating point of the holding bracket by
decreasing a thickness of the inner or outer support wall, a number of the stiffening elements or a size of the stiffening elements when the degree of utilization exceeds a prescribed upper limit value., and
increasing the thickness of the outer or inner support wall, the number of stiffening elements, or the size of the stiffening elements when the degree of utilization falls below a prescribed lower limit value; and
(c) repeating (a) and (b) after a change in the at least one selected from the group consisting of the geometry and the position.

2. The device of claim 1, wherein the polymer material is a reinforced plastic comprising fibers.

3. The device of claim 2, the process further comprising, prior to (a):
performing a simulation calculation to determine an orientation of the fibers and any weld lines in the holding bracket.

4. The device of claim 1, wherein the polymer material comprises a polyamide, a polyester, a polyacetal, a polysulfone, a polyphenylene sulfide, a polyolefin or mixtures thereof.

5. The holding device of claim 2, wherein the fibers are glass fibers, carbon fibers, or aramid fibers.

6. The device of claim 5, wherein the fibers have a length in a range of from 0.1 to 20 mm.

7. The device of claim 1, wherein the elastic material is selected from the group consisting of a natural rubber, an ethylene-propylene-diene terpolymer, a nitrile butadiene rubber, a styrene-butadiene rubber, a thermoplastic polyurethane, and a silicone.

8. The device of claim 1, wherein the holding bracket and the mount are connected to one another by encapsulation of the mount with the polymer material of the holding bracket.

9. The device of claim 1, further comprising a bush mounted in the holding bracket.

10. The device of claim 1, further comprising a functional element on the holding bracket.

11. The device of claim 1, wherein the holding bracket is formed as at least two parts.

12. The device of claim 1, further comprising, a through-opening on the holding bracket, wherein the through-opening comprises an elastomer material on an underside.

13. A process for designing a holding device comprising a mount comprising an elastic material and a holding bracket produced from a reinforced plastic comprising fibers, which at least partially encloses the mount of the elastic material, comprising an inner support wall and an outer support wall, which are connected to one another by a ribbed structure comprising stiffening elements, the process comprising:
(a) calculating a degree of utilization of a strength of the holding bracket by a simulation calculation;
(b) adapting at least one selected from the group consisting of a geometry of the holding bracket and a position of at least one gating point of the holding bracket by
decreasing a thickness of the inner or outer support wall, a number of the stiffening elements, or a size of the stiffening elements when the degree of utilization exceeds a prescribed upper limit value, and
increasing the thickness of the inner or outer support wall, the number of stiffening elements, or the size of the stiffening elements when the degree of utilization falls below a prescribed lower limit value; and
(c) repeating steps (a) and (b) after a change in the at least one selected from the group consisting of the geometry the position.

14. The process of claim 13, further comprising, prior to (a);
performing a simulation calculation to determine an orientation of the fibers and any weld lines in the holding bracket.

15. The device of claim 1, wherein the device is suitable for fixing an axle stabilizer in a motor vehicle

16. The device of claim 1, wherein the polymer material comprises a polyamide.

17. The device of claim 5, wherein the fibers have a length of less than 0.4 mm.

18. The device of claim 5, wherein the fibers are glass fibers having a length of less than 0.4 mm.

19. The device of claim 1, wherein the elastic material is a natural rubber.

20. The device of claim 1, wherein the elastic material is an ethylene-propylene-diene terpolymer.
